(19) United States
(12) Patent Application Publication
(10) Pub. No.: US 2006/0151623 A1
(43) Pub. Date: Jul. 13, 2006

(54) Heat exchanger body and vehicle heater with a heat exchanger body

(76) Inventors: Michael Haefner, Stuttgart (DE); Andreas Collmer, Aichwald (DE)

Correspondence Address: MCGLEW & TUTTLE, PC, P.O. BOX 9227, SCARBOROUGH STATION, SCARBOROUGH, NY, 10510-9227, US

(21) Appl. No.: 11/317,784

(22) Filed: Dec. 23, 2005

(30) Foreign Application Priority Data
Jan. 13, 2005 (DE) 10 2005 001 662.6

(51) Int. Cl. B60H 1/00

(52) U.S. Cl. 237/12.3 C

(57) ABSTRACT

A heat exchanger body for a vehicle heater has an elongated circumferential wall (26), which defines a flow space (40) for combustion products together with an inner side (38). The circumferential wall (26) is essentially not provided with heat transfer ribs on its inner side (38) in a first length section (50) of the flow space (40), which said first length section leads away from an inlet opening (44). The circumferential wall (26) is provided with heat transfer ribs (56) on its inner side (38) in a second length section (52) leading to an outlet area (48).

### CROSS REFERENCE TO RELATED APPLICATIONS

This application claims the benefit of priority under 35 U.S.C. § 119 of German Patent Application 10 2005 001 662.6 filed Jan. 13, 2005, the entire contents of which are incorporated herein by reference.

### FIELD OF THE INVENTION

The present invention pertains to a heat exchanger body for a vehicle heater and to a vehicle heater with such a heat exchanger body, wherein the heat exchanger body has an elongated circumferential wall, which defines with its inner side a flow space for combustion products.

### BACKGROUND OF THE INVENTION

Such a heat exchanger body or a vehicle heater with such a heat exchanger body is known from DE 102 11 591 A1. The heat exchanger body is of an essentially pot-shaped design with its circumferential wall and carries in its open end area the burner device, in which hot combustion products are formed during combustion. After having passed through a comparatively short flame tube, these hot combustion products enter an inlet area of a flow space provided in this heat exchanger body, which said inlet area is located close to the open end area of the heat exchanger body. Heat transfer ribs leading in the direction of an outlet area are provided on the inner side of the circumferential wall in this flow space. The height and consequently also the surface of these heat transfer ribs increase in the direction from the inlet area to the outlet area. The outlet area is formed close to the bottom of the heat exchanger body joining the circumferential wall in the form of a lateral opening. The combustion products, which are caused to flow along the heat exchanger body and are cooled in the process, leave the flow space through this lateral opening and in the direction of a drain tube.

### SUMMARY OF THE INVENTION

The object of the present invention is to provide a heat exchanger body for a vehicle heater and a vehicle heater in which the heat transfer to the heat exchanger body can be made with increased efficiency and in a more uniform manner.

According to a first aspect of the present invention, this object is accomplished by a heat exchanger body for a vehicle heater, comprising an elongated circumferential wall, which defines a flow space for combustion products with an inner side, wherein the circumferential wall is essentially not provided with heat transfer ribs in a first length section of the flow space leading away from an inlet area and the circumferential wall is provided with heat transfer ribs on its inner side in a second length section leading to an outlet area.

The heat exchanger body is provided with an essentially unstructured form, i.e., with a surface not provided with ribs, in a first length section. The combustion products flow through this flow space area, in which this flow space area offers a comparatively small heat transfer surface relative to a unit of length of the circumferential wall in the direction of its longitudinal extension. Heat transfer ribs, which lead to a marked enlargement of the heat transfer surface provided per unit of length of the circumferential wall, are then provided in the second length section, through which the combustion products will then flow when such has already released part of their heat. The combustion products, which are already cooled, will thus come into contact with a larger surface area, which enables a larger amount of energy to be able to be transferred to the heat exchanger body even in these areas, through which flow takes place only later and through which cooler combustion products will consequently flow. The amount of energy introduced into the heat exchanger body over its length thus becomes markedly more uniform.

Provisions may be made, for example, for the circumferential wall to be expanded in a stepped manner on the inner side in a transition area from the first length section to the second length section.

To make manufacturing easier according to a casting method and to improve the heat transfer, it is proposed that the heat transfer ribs extend away from the transition area such that an apex of at least some of the heat transfer ribs will join the inner surface of the circumferential wall in the first length section in an essentially continuous manner. Furthermore, provisions may be made in this connection for an internal dimension of the circumferential wall to increase in the direction of the outlet area.

The possibility of manufacturing according to a casting method can be additionally facilitated by the apex areas diverging from one another in the direction of the outlet area. The mold release slope, which is generally necessary for carrying out metal casting methods and is advantageous, can be provided in this manner not only in the area of the circumferential wall, but also in the area of the apex of the heat transfer ribs.

To make it possible to better utilize the heat introduced by the hot combustion products into the circumferential wall, it is proposed that heat transfer ribs be provided on an outer side of the circumferential wall to transfer heat to a medium to be heated.

According to another aspect, the object stated in the introduction is accomplished by a vehicle heater, comprising a burner device with a flame tube, which guides combustion products in the direction away from a combustion chamber, a heat exchanger body according to the present invention, wherein the flame tube extends into the heat exchanger body and defines the flow space together with the circumferential wall thereof, wherein the flame tube guides, furthermore, the combustion products in the direction of the inlet area of the flow space.

It is especially advantageous in the embodiment according to the present invention that the flow space for the combustion products is defined, on the one hand, by the circumferential wall, i.e., the heat exchanger body itself, and, on the other hand, by the flame tube guiding the combustion products, i.e., the combustion products, which have already introduced heat into the heat exchanger body during the flow through the flow space, can also absorb heat from the flame tube, which is flown past by the very hot combustion products, due to flowing along same on the inside thereof and thus they also have a sufficiently high temperature in the sections of the flow space that are located close to the outlet area to support uniform introduction of heat into the heat exchanger body over the length thereof.

In adaptation to the shape of the circumferential wall, provisions may be made for the flame tube to have a stepped change in its dimension close to the transition area.

Furthermore, more uniform transfer of heat to the heat exchanger body can be supported by the flame tube having at least one intermediate discharge opening for combustion products toward the flow space in its area defining the second length section of the flow space.

The present invention will be described in detail below in reference to the attached drawings. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a longitudinal sectional view of a vehicle heater according to the present invention;

FIG. 2 is a longitudinal sectional view of the heat exchanger body used in the vehicle heater according to FIG. 1;

FIG. 3 is a view of an alternative embodiment of a vehicle heater according to the present invention, which corresponds to the view in FIG. 1.

### DESCRIPTION OF THE PREFERRED EMBODIMENTS

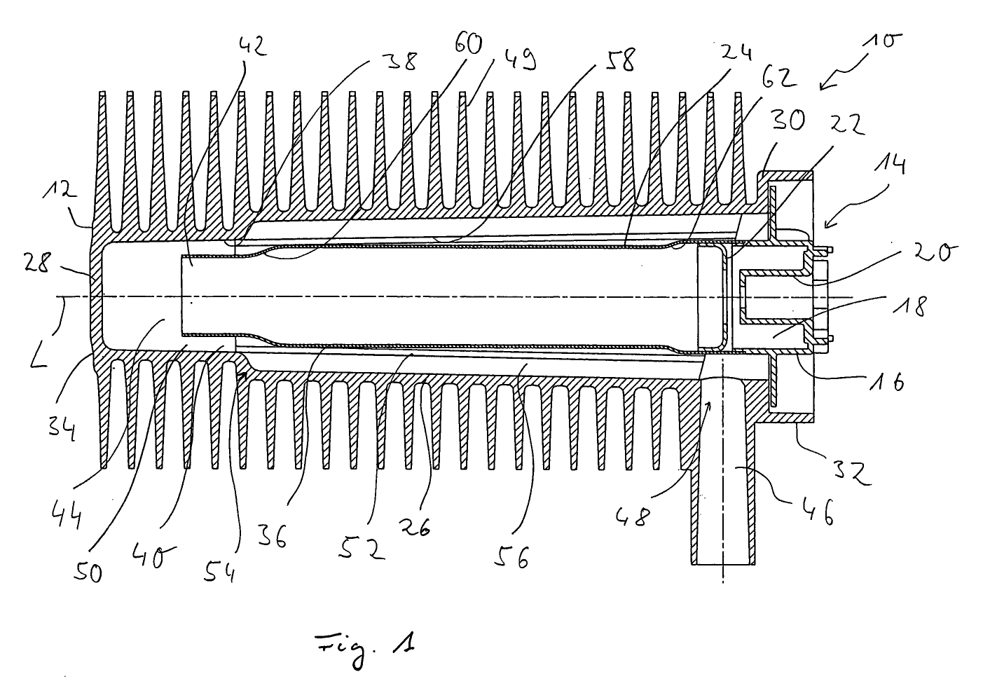

Referring to the drawings in particular, a vehicle heater according to the present invention is generally designated by 10 in FIG. 1. Such a vehicle heater 10 can be used to heat the air to be introduced into the interior space of a vehicle. It has, for thus purpose, a heat exchanger body, generally designated by 12, which absorbs combustion heat and transfers same to the air flowing past it, as will be described below.

Besides the heat exchanger body 12 already mentioned, the vehicle heater 10 has a burner device 14 as another essential system area. This burner device 14 forms, in a combustion chamber housing 16, a combustion chamber 18, in which fuel is introduced via a fuel feed line and optionally a porous evaporator medium and, furthermore, the necessary combustion air is introduced via an air intake pipe 20. The mixture of fuel and combustion air can be ignited by an igniting member, which is not shown specifically. The hot combustion products leave the combustion chamber 18 and the combustion chamber housing 16 and enter a flame tube, which is generally designated by 24, through a flame diaphragm 22. This flame tube 24 is rigidly connected to the combustion chamber housing 16 and is elongated lengthwise along a longitudinal axis L. While the combustion chamber 16 is generally provided as a cast part, the flame tube 24 may be manufactured, for example, from a sheet metal.

Just like the flame tube 24, the heat exchanger body 12 is also elongated in the direction of the longitudinal axis L and has a circumferential wall 26 elongated in this direction. The heat exchanger body 12 is of an essentially pot-shaped design and also has, besides the circumferential wall 26, a bottom wall 28, which directly joins the circumferential wall 26. The circumferential wall 26 and the bottom wall 28 thus form an overall device, which is open in an end area and carries the combustion chamber housing 16 there via a connection attachment 30, but is completely closed in the other end area, so that no combustion waste gases can escape.

The flame tube 24 extends into this elongated device and thus guides the combustion products from the open end 32 of the heat exchanger body 12 in the direction and into the vicinity of the closed end 34 thereof.

A flow space, generally designated by 40, is formed between an outer side 36 of the flame tube 24 and an inner side 38 of the circumferential wall 26 or the bottom wall 28. Thus, an inlet area 44 is formed for this flow space 40 at the axial end 42 of the flame tube 24, which axial end is located away from the combustion chamber 18, and the hot combustion products, which are guided at first along the flame tube 24 and leave same at the end 42 of the flame tube, enter the flow space 40 defined by the heat exchanger body 12 toward the outside. The flowing combustion products are also deflected in this inlet area 44 essentially by the bottom wall 28, so that they are now flowing back along the outer side 36 of the flame tube 24 or the inner side 38 of the circumferential wall 26 in the direction of the open end 32 of the heat exchanger body 12. An outlet area of the flow space 40, which is generally designated by 48, is provided there by a lateral outlet opening 46. Consequently, after having entered the flow space 40 in the inlet area 44, the combustion products flow back along this flow space 44 in a direction that is essentially opposite the direction of flow in the inner volume area of the flame tube 24, in the direction of the outlet area 48 and leave the flow space 40 or the inner volume area of the heat exchanger body 12 there. During this flow along the flow space 40 and along the inner side 38 of the circumferential wall 26 or the bottom wall 28, the hot combustion products transfer heat to the heat exchanger body 12. This heat is transported through the circumferential wall 26 and, of course, also the bottom wall 28. Furthermore, heat transfer ribs, which absorb the heat introduced into the heat exchanger body 12 and provide a very large surface to be flown past by the medium to be heated, i.e., for example, air, are provided on the outer side of the circumferential wall 26. This medium flows essentially at right angles to the longitudinal axis L around the heat exchanger body 12 and absorbs heat above all in the area of the heat transfer ribs 49.

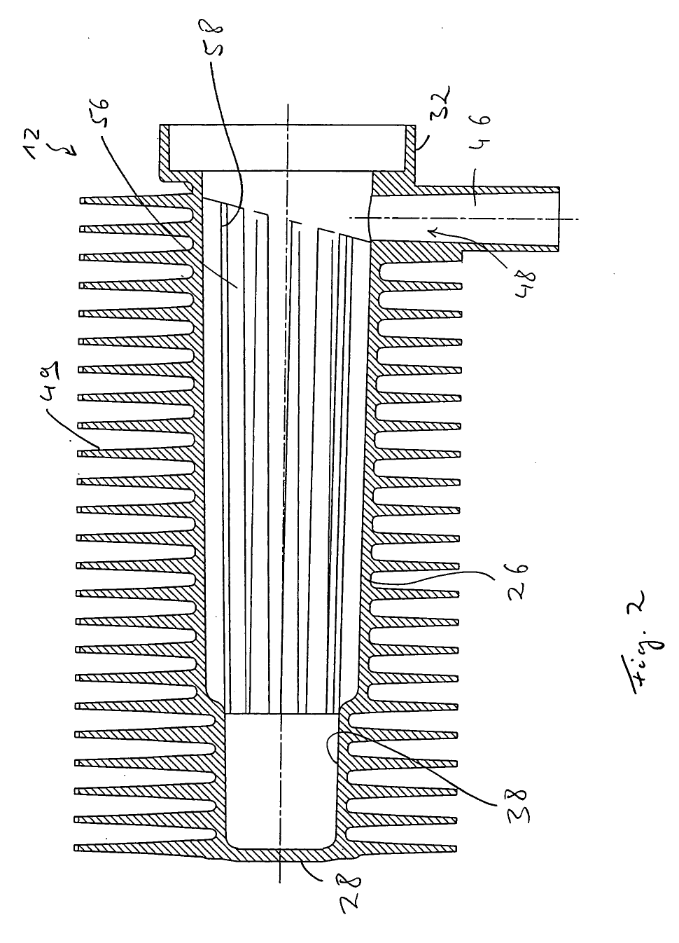

To make the transfer from the hot combustion products to the heat exchanger body 12 very efficient, the flow space 40 is divided essentially into two length sections. A first length section 50 comprises, for example, the inlet area 44 and leads away from same. The heat exchanger body 12 and the circumferential wall 26 thereof are provided with an essentially smooth, unstructured surface in this first length section 50, i.e., no elevations or depressions that would essentially affect the surface provided are formed on the inner side 38 in his first length section 50. In a second length section 52, which joins the first length section 50 in a transition area 54, the inner side 38 of the circumferential wall 26 is formed with heat transfer ribs 56, which extend approximately in the direction of flow, i.e., in the direction of the outlet area 48. These heat transfer ribs 56 can be clearly recognized especially in FIG. 2. The heat transfer ribs 56 enlarge the surface of the circumferential wall 26 and of the heat exchanger body 12 that is available for the absorption of heat relative to a particular unit of length thereof in the direction of the longitudinal axis L compared to a surface not provided with such ribs, i.e., an essentially unstructured surface, as it is provided in the first length section 50. This means that the combustion products, which release heat during their flow along the inner side 38 in the first length section 50 and cool in the process, come into contact with a markedly enlarged surface of the heat exchanger body 12 after flowing through the transition area 54 and after entering the second length section 52 and thus they can introduce an approximately constant amount of heat energy—again relative to a flown-through unit of length of the heat exchanger body 12 in the direction of the longitudinal axis L—into the heat exchanger body 12 because of the enlarged heat transfer surface despite the already lower temperature. This is additionally supported by the fact that the circumferential wall 26 is designed such that it expands in the direction of the outlet area 48, so that the heat transfer surface of the circumferential wall 26, which is provided per unit of length, increases as a result.

It is also recognized in FIGS. 1 and 2 that the transition area 54 between the two length sections 50, 52 is designed as a stepped area, so that the dimension of the circumferential wall or the internal diameter of the volume thus provided increases stepwise at least on the inner side 38. However, the apex areas 58 of the heat transfer ribs 56 are designed such that they join the inner side 38 of the circumferential wall 26 in the first length section 50 flush, i.e., they essentially continue same without a stepped transition. Furthermore, it is recognized that the apex areas 58 likewise diverge in the direction of the outlet area 48, i.e., also diverge apart from one another corresponding to the expanding shape of the circumferential wall 26, so that, for example, the mutual distance between heat transfer ribs that are diametrically opposite or approximately diametrically opposite each other relative to the longitudinal axis L in the apex areas 58 thereof increases in the direction of the outlet area 48. Thus, in adaptation to the correspondingly expanding shape of the circumferential wall 26, not only is an increasing surface provided per unit of length of the heat exchanger body 12, but the mold release slope, which is advantageous or necessary especially if the heat exchanger body 12 is manufactured according to a metal casting method, is provided as well. However, to prevent an excessive increase in the volume of the flow space 40 from forming in case of increasing surface of the heat exchanger body 12 per unit of length thereof, which would lead to a drop in pressure, the flame tube 24 is provided with a change in dimension in a transition area 60 corresponding to the stepped expansion of the circumferential wall 26 in the transition area 54, so that it is tapered in the direction of its end 42 located away from the combustion chamber 18 or it is expanded in the direction in which the combustion products flow in the flow space 40. Another stepped transition 62 is now provided close to the point at which the flame tube 24 is connected to the heat exchanger housing 26.

Highly efficient heat transfer from the hot combustion products to the heat exchanger body 12 is guaranteed with the above-described design of the heat exchanger body 12 and of the vehicle heater 10 because of the shape of the heat exchanger body 12, on the one hand, and because of the shape and the positioning of the flame tube 24, on the other hand. Furthermore, it is ensured that the heat transfer between the two ends 34 and 32 of the heat exchanger body 12 is approximately equal, again relative to a particular unit of length of the heat exchanger body 12. This is ensured, on the one hand, by the shape. On the other hand, the flame tube 24 makes an essential contribution. This guides on its inner side the very hot combustion products leaving the combustion chamber 18 and guides them, before they can come into thermal contact with the heat exchanger body 12 at all, to its closed end 34. It is only there that the hot combustion products can then come into contact with the inner side 38 and transfer heat to the heat exchanger body 12. However, the combustion products, which will then actually be cooling due to the thermal contact with the heat exchanger body 12 during their flowing back, are likewise in thermal contact with the outer side 36 of the flame tube 24 and can thus again absorb heat from still hotter combustion products flowing in the inner volume area of the flame tube 24 during the flow in the direction of the outlet area 48. Consequently, not only do the combustion products flowing through the flow space 40 transfer the combustion heat being transported in this space 40 to the heat exchanger body 12, but also act at the same time as a transfer medium for transferring heat from the outer side 36 of the flame tube 24 to the inner side 38 of the circumferential wall 26 and of the heat exchanger body 12.

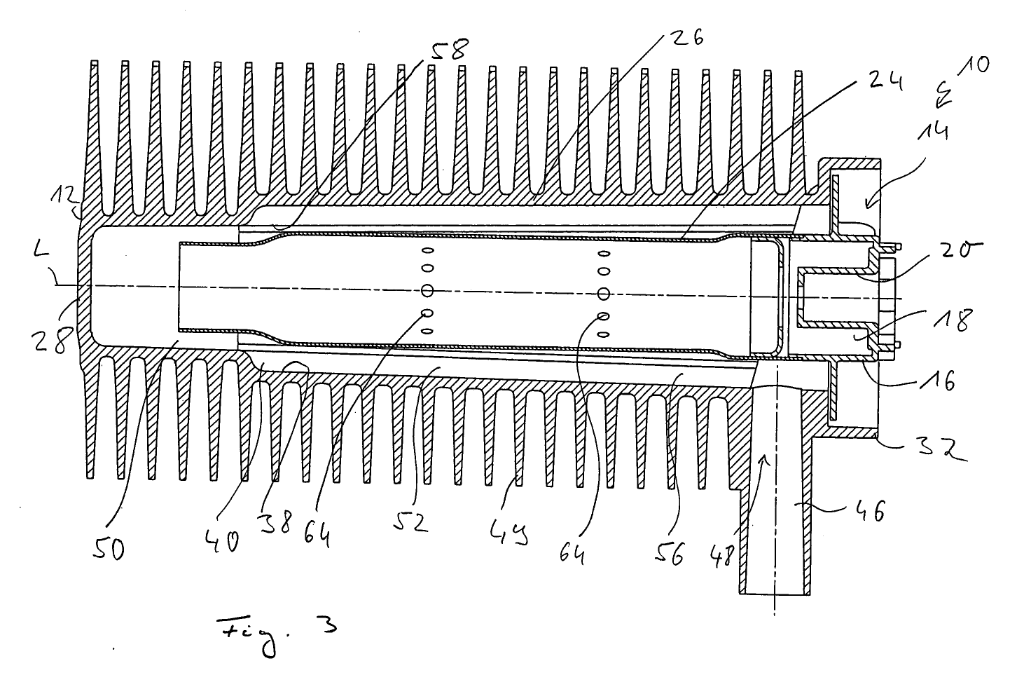

Another manner of embodying the heater according to the present invention is shown in FIG. 3. The design corresponds basically to that described above in reference to FIGS. 1 and 2, so that reference can be made to these explanations. However, it is recognized that two rows of rings of intermediate outlet openings 64 are provided in the flame tube 24, in its section defining the second length section 52 of the flow space 40 together with the circumferential wall 26 of the heat exchanger body 12. Part of the combustion products flowing in the flame tube 24 in the direction away from the combustion chamber 18 can enter directly the second length section 52 of the flow space 40 through these intermediate outlet openings 64. These combustion products, which are still very hot, mix thoroughly with the already somewhat cooled combustion products that flow in from the flow space 40 from a farther upstream area and thus ensure a further increase in the uniformity of the temperature of the combustion products in the flow space 40 and thus a further increase in the uniformity of heat transfer to the heat exchanger body 12. The number of intermediate discharge openings 64, the size thereof and the positioning thereof at the flame tube 24 may, of course, be selected to be such that an additional optimization can be achieved by a corresponding stepping of these intermediate outlet openings 64. For example, the opening cross section of these outlet openings or the overall cross section of the intermediate outlet openings 64, which is provided in a particular length area of the flame tube 24, may decrease in the direction of the end 42.

While specific embodiments of the invention have been shown and described in detail to illustrate the application of the principles of the invention, it will be understood that the invention may be embodied otherwise without departing from such principles.

What is claimed is:

1. A heat exchanger body for a vehicle heater, the heater heat exchange comprising:
an elongated circumferential wall which defines with an inner side a flow space for combustion products, the flow space having an inlet area, said circumferential wall defining a first length section of said flow space, with said circumferential wall having an inner side essentially without heat transfer ribs, said first length section leading away from said inlet area, said circumferential wall defining a second length section of said flow space, with said circumferential wall having heat transfer ribs on said inner side, said second length section leading to an outlet area.

2. A heat exchanger body in accordance with claim 1, wherein said circumferential wall expands in a stepped manner at least on said inner side in a transition area from said first length section to said second length section.

3. A heat exchanger body in accordance with claim 2, wherein said heat transfer ribs extend away from said transition area such that at least some of said heat transfer ribs have an apex that essentially continuously joins the inner surface of said circumferential wall in said first length section.

4. A heat exchanger body in accordance with claim 1, wherein an internal dimension of said circumferential wall increases in the direction of said outlet area.

5. A heat exchanger body in accordance with claim 2, wherein an internal dimension of said circumferential wall increases in the direction of said outlet area.

6. A heat exchanger body in accordance with claim 3, wherein an internal dimension of said circumferential wall increases in the direction of said outlet area.

7. A heat exchanger body in accordance with claim 3, wherein said apex areas of said heat transfer ribs extend away from each other in the direction of said outlet area.

8. A heat exchanger body in accordance with claim 1, wherein said heat transfer ribs are provided on an outer side of said circumferential wall for transferring heat to a medium to be heated.

9. A vehicle heater, comprising:
a burner device with a combustion chamber and a flame tube guiding combustion products in a direction away from said combustion chamber;
a heat exchanger body comprising:
an elongated circumferential wall which defines with an inner side a flow space for combustion products, the flow space having an inlet area, said circumferential wall defining a first length section of said flow space, with said circumferential wall having an inner side essentially without heat transfer ribs, said first length section leading away from said inlet area, said circumferential wall defining a second length section of said flow space, with said circumferential wall having heat transfer ribs on said inner side, said second length section leading to an outlet area, wherein said flame tube extends into said heat exchanger body and defines said flow space together with said circumferential wall and wherein said flame tube guides said combustion products in the direction of said inlet area of said flow space.

10. A vehicle heater in accordance with claim 9, wherein:
said circumferential wall expands in a stepped manner at least on said inner side in a transition area from said first length section to said second length section; and
said flame tube has a stepped change in dimension close to said transition area.

11. A vehicle heater in accordance with claim 9, wherein said flame tube has at least one intermediate outlet opening for combustion products, said intermediate outlet being directed toward said flow space in an area defining said second length section of said flow space.

12. A vehicle heater, comprising:
a burner device with a combustion chamber and a flame tube guiding combustion products in a direction away from said combustion chamber;
a heat exchanger body with an elongated circumferential wall with an inner side cooperating with an outer side of said flame tube to define a flow space for flow of combustion products, the flow space having an inlet area adjacent to an outlet of said flame tube wherein said flame tube guides said combustion products in the direction of said inlet area of said flow space, said circumferential wall defining a first length section of said flow space, with said circumferential wall having an even surface inner side, said first length section leading away from said inlet area, said circumferential wall defining a second length section of said flow space, with said circumferential wall having heat transfer ribs on said inner side, said second length section leading to an outlet area.

13. A vehicle heater in accordance with claim 12, wherein:
said circumferential wall expands in a stepped manner at least on said inner side in a transition area from said first length section to said second length section; and
said flame tube has a stepped change in dimension close to said transition area.

14. A vehicle heater in accordance with claim 13, wherein said flame tube has at least one intermediate outlet opening for combustion products, said intermediate outlet being directed toward said flow space in an area defining said second length section of said flow space.

15. A vehicle heater in accordance with claim 12, wherein said flame tube has at least one intermediate outlet opening for combustion products, said intermediate outlet being directed toward said flow space in an area defining said second length section of said flow space.
